(19) United States
(12) Patent Application Publication
(10) Pub. No.: US 2026/0230504 A1
(43) Pub. Date: Aug. 6, 2026

(54) PHISHING DETECTION ENGINE(S) FOR AUTONOMOUS PHISHING IDENTIFICATION

(71) Applicant: Microsoft Technology Licensing, LLC, Redmond, WA (US)

(72) Inventors: Gilad KIRSHENBOIM, Petach Tiqva (IL); David Natan KAPLAN, Modi'in (IL); Aviel LAVIE, Tel Aviv (IL); Lior LIBERMAN, Tel Aviv (IL); Roei Shlomo MENASHOF, Netanya (IL); Ori LASLO, Rehovot (IL)

(21) Appl. No.: 19/046,725

(22) Filed: Feb. 6, 2025

(51) Int. Cl. H04L 9/40; H04L 41/16

(52) U.S. Cl. CPC H04L 63/1483; H04L 41/16

(57) ABSTRACT

Systems and methods herein provide a phishing detection engine and its related functions. In an aspect, a phishing detection engine captures focal content displayed via a user interface on a client device. From the focal content, the phishing detection engine extracts features. These features include textual elements and visual elements. Using the features, and in some cases historical user interactions associated with the client device, the phishing detection engine determines whether the features indicate potential phishing activity. If potential phishing activity is detected from the features, the phishing detection engine performs one or more security actions to limit damage of the potential phishing activity, such as blocking execution of an activation step of the phishing activity. In scenarios where the phishing activity is indeterminate, the phishing detection engine may continue to monitor the user's content interaction and extract features from subsequent contents, until a determinate conclusion is reached.

### TECHNICAL FIELD

Aspects of the disclosure are related to the field of computer software applications and services and, in particular, to phishing detection engines for autonomously detecting and identifying potential phishing activity.

### BACKGROUND

In the modern era of digital interconnectedness, phishing activity has emerged as a prevalent and growing threat. Phishing is a form of cyberattack in which malicious actors impersonate legitimate organizations or individuals to deceive users into revealing sensitive information, such as passwords, credit card numbers, or personal data. Often conducted through fraudulent emails, text messages, or fake websites, phishing exploits human trust and can lead to identity theft, financial loss, and data breaches. As reliance on digital platforms grows, phishing schemes are becoming more sophisticated and harder to detect, amplifying the risks for individuals and businesses. Beyond financial and personal security threats, these evolving attacks undermine trust in digital communication and online services, creating widespread vulnerabilities in an increasingly connected world.

### SUMMARY

Technology disclosed herein includes software applications and services that provide a phishing detection engine, and its related functions. In an aspect, a phishing detection engine determines focal content displayed on a user interface of a client device. For example, the phishing detection engine may detect an application displaying active content and capture a screenshot of the active content. Once determined, the phishing detection engine extracts features from the focal content. The features may include textual elements, such as domain names, URLs, text summaries, and/or image elements, such as logos, buttons, or images. The phishing detection engine then processes these features to determine whether they indicate potential phishing activity.

In an embodiment, to process the features extracted from the focal content, the phishing detection engine submits the features to a model, which may be a machine-learning model. The model is trained on historical datasets containing features extracted from other content interactions. These features may have corresponding labels that identify whether the features indicate potential phishing activity or not. In some cases, the model is tailored to a particular client device or user, such to detect which features are associated with normal content interaction for that particular client device or user.

Responsive to submitting the features extracted from the focal content into the model, the phishing detection engine receives the output from the model. The output may include a score indicating the likelihood or probability that the focal content contains potential phishing activity or may include a labeling of whether or not the features indicate phishing activity. For example, the output from the model may classify the features as “not phishing activity” or as “phishing activity.” In another example, the output may be a probability or score, such as 86% likelihood that the features indicate potential phishing activity. Based on this output then, the phishing detection engine determines a risk level of the potential phishing activity, such as high risk, low risk, or indeterminate risk.

In some embodiments, the phishing detection engine determines that based on the current focal content, the risk level of phishing activity is indeterminate. That is, the phishing detection engine is unable to accurately classify the features as potential phishing activity with a predefined degree of certainty. In such cases, the phishing detection engine monitors subsequent content interactions and extracts features from those interactions for processing. Based on the features from both the subsequent content interactions and the initial focal content, the phishing detection engine determines whether there is any evidence of phishing activity.

Once potential phishing activity is detected, the phishing detection engine performs one or more security actions to limit any damage or repercussions of the attack. For example, the phishing detection engine may prevent execution of an activation step for the phishing activity, such as blocking a deceptive URL. In other cases, if the phishing activity is successful, such as the user inadvertently downloads malicious material, the phishing detection engine generates a summary of the phishing activity and sends it to an associated security system. The summary may include screenshots of the focal content during the phishing attack, a rationale as to why the phishing detection engine identified the content as potential phishing activity, and other information related to the phishing attack (e.g., filename of downloaded malicious content, deceptive URL).

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a phishing detection engine, according to an embodiment herein;

FIG. 2 illustrates an example system in which a phishing detection engine is provided, according to an embodiment herein;

FIG. 3 illustrates a process for providing a phishing detection engine and its related functions, according to an embodiment herein;

FIG. 4 illustrates an example environment illustrating focal content identified as containing potential phishing activity, according to an embodiment herein;

FIG. 5 provides an example notification provided to a client device responsive to a security action, according to an embodiment herein;

FIG. 6 illustrates an example including focal content resulting in an indeterminate risk level classification, according to an embodiment herein;

FIG. 7 illustrates a subsequent content interaction, according to an embodiment herein;

FIG. 8 illustrates an example depicting focal content containing various features, according to an embodiment herein;

FIG. 9 illustrates an example depicting focal content captured by a phishing detection engine at a subsequent time to analysis of the focal content provided in FIG. 8, according to an embodiment herein;

FIG. 10 illustrates an example notification generated by a phishing detection engine responsive to detecting activation of phishing activity; and

FIG. 11 shows an example client device suitable for providing a phishing detection engine and related functions, according to an embodiment herein.

### DETAILED DESCRIPTION

Phishing attacks are one of the most widespread forms of cybercrime, characterized by deceptive attempts to obtain sensitive information from individuals and organizations. Attackers often impersonate trusted entities through emails, messages, or fraudulent websites, creating a false sense of urgency to manipulate victims into revealing personal data, financial information, or login credentials. These attacks can result in unauthorized access to accounts, data breaches, and financial losses. Phishing schemes continue to evolve, utilizing more convincing tactics and targeting a broad range of industries and users, contributing to their persistent success and growing prevalence in the digital landscape.

As phishing techniques evolve, attackers are employing increasingly sophisticated methods that make it harder to distinguish fraudulent communications from legitimate ones. Modern phishing campaigns often use highly personalized messages, leveraging data gathered from social media or previous breaches to tailor their approach to specific individuals or organizations. These messages may bypass traditional warning signs, such as spelling errors or generic greetings, and instead mirror the tone, branding, and email formats of trusted entities with alarming accuracy. This heightened level of detail puts individuals who are less “security-aware” at greater risk, as they may be more likely to trust and respond to these convincing attempts. The growing use of advanced tools like AI-generated text and deepfake technology further amplifies the effectiveness of phishing, allowing attackers to craft more targeted and credible lures that can deceive even cautious users.

Conventional approaches to addressing phishing attacks, such as spam filters and automated threat detection, often fall short in fully preventing these cyber threats because phishing techniques frequently exploit the naivety or inattention of the victim. While security tools can block known malicious links or flag suspicious emails, they cannot entirely account for the human element—the tendency of users to trust familiar-looking communications or overlook subtle warning signs. Attackers continuously adapt, crafting emails that bypass automated defenses by mimicking internal correspondence or exploiting current events to appear credible. This reliance on social engineering allows phishing attempts to slip through technical barriers, placing the burden on individuals to recognize and resist manipulation. Moreover, conventional approaches are often focused on specific places or applications for phishing attacks, failing to capture the entire user context. As a result, even the most advanced cybersecurity infrastructure can be undermined by a single moment of user error, reflecting the limitations of traditional defense mechanisms in combating increasingly deceptive phishing tactics.

The consequences of phishing attacks can be severe, resulting in significant financial, operational, and reputational damage for individuals and organizations. Victims may suffer from identity theft, unauthorized transactions, and drained bank accounts, while businesses can face data breaches, loss of sensitive information, and disrupted operations. Beyond immediate financial losses, phishing attacks often lead to long-term impacts, such as legal liabilities, regulatory penalties, and erosion of customer trust. For organizations, compromised credentials can grant attackers access to internal networks, potentially facilitating further attacks like ransomware deployment or intellectual property theft. The cascading effects of a successful phishing incident can undermine an entity's stability, highlighting the extensive damage that can arise from a single deceptive email or message.

To address at least the shortcomings of conventional approaches to phishing attacks, an example phishing detection engine is provided herein. In particular, a phishing detection engine autonomous phishing identification is described. As will be described in greater detail below, the phishing detection engine monitors focal content that a user interacts with via a user interface of a respective client device. The focal content, as used herein, refers to active content or the primary elements within the user interface that is currently the center of user interaction. For example, the focal content may be an email that the user opens and is reading via the user interface.

The phishing detection engine monitors the focal content to determine whether the focal content contains any indication of phishing activity. Specifically, the phishing detection engine extracts the features of the focal content and processes the features to detect evidence of potential phishing activity. As will be described in greater detail below, the features may include textual elements, such as headings, body text, labels, buttons (e.g., “Submit”, “Accept”), links (e.g., URLs), and error messages, as well as image elements, such as icons (e.g., a trash can or logos), buttons with icons, thumbnails, and data visualizations. Once extracted, the phishing detection engine processes the features to determine whether there is any evidence of potential phishing activity present within the features. In other words, the phishing detection engine monitors the focal content to determine whether any phishing features are present within the content that the user actively interacts with. Phishing features may include a deceptive URL, discrepancies between the logo and the email domain name, or unsolicited requests for sensitive information.

In some embodiments, the phishing detection engine actively monitors the user interface for potential phishing activity. For instance, the phishing detection engine may capture the focal content of the user interface at predefined time increments and extract the respective features for processing at each time interval. In this manner, the phishing detection engine can minimize the risk of phishing attacks at each stage of a user interaction. In some embodiments, the phishing detection engine monitors focal content provided by certain applications that are vulnerable to phishing attacks, such as messaging application or web-based applications. While, in other embodiments, the phishing detection engine monitors focal content provided by any application presenting content via the user interface.

Responsive to detecting potential phishing activity, the phishing detection engine determines a risk level of the respective phishing activity. Depending on the risk level, the phishing detection engine performs one or more security actions to minimize the damage of the phishing activity. For example, if the phishing detection engine determines a high-risk of phishing activity, the phishing detection engine may prevent execution of the potential phishing activity, such as blocking a URL or access to a web-page. In some cases, the phishing detection engine determines that the risk level is indeterminate for phishing activity. As such, the phishing detection engine monitors subsequent content interactions performed via the user interface, extracting the features of the focal content from these interactions to determine whether there is any indication of potential phishing activity. If there is, the phishing detection engine initiates one or more security actions to prevent or limit the potential phishing activity.

The phishing detection engine offers significant benefits by accurately and automatically identifying phishing activity, thereby enhancing cybersecurity. By actively monitoring content interactions performed via the user interface, the phishing detection engine can detect potential phishing activity in real-time, without relying on manual intervention or user awareness. This ensures rapid identification and blocking of phishing attempts before they reach the victim, reducing the risk of data breaches, financial loss, and reputational damage. As will be described in greater detail, the phishing detection engine continuously evolves, learning from new attack vectors and adapting to emerging phishing techniques, making them more effective over time. Moreover, the phishing detection engine may tailor its phishing activity identification based on a respective user's known content interactions, thereby minimizing false alarms. By reducing the burden on users to recognize threats and providing a proactive defense, the phishing detection engine contributes to a more secure digital environment, offering peace of mind for individuals and organizations alike.

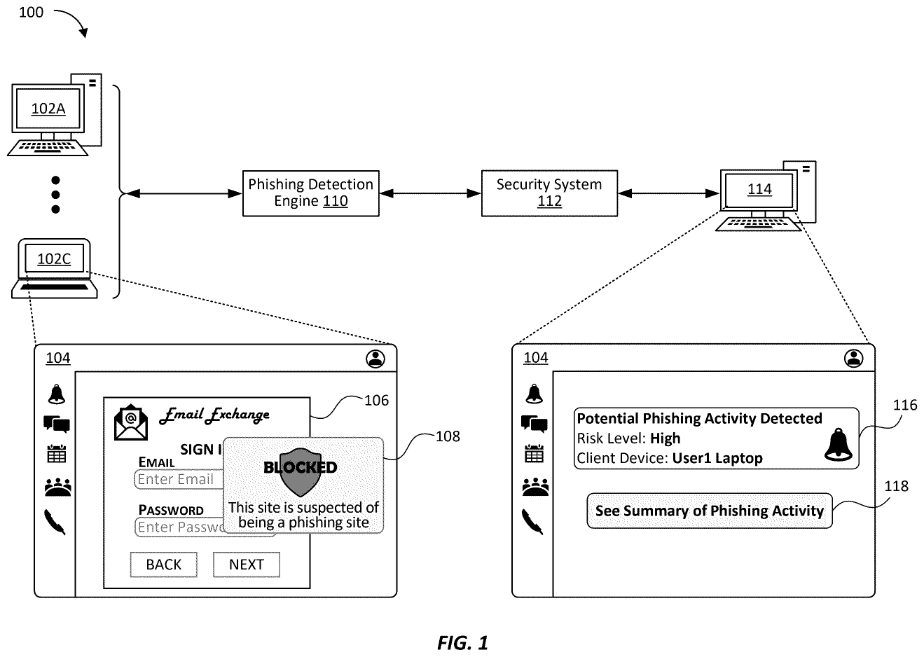

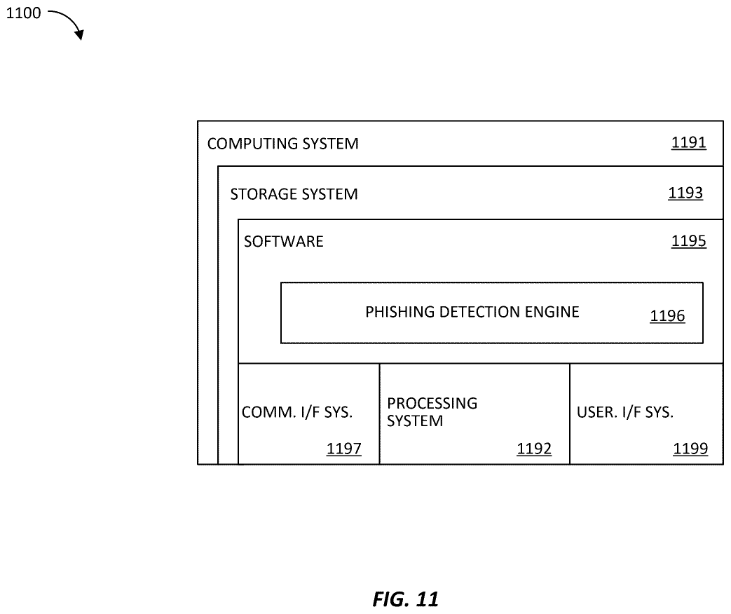

Turning now to the Figures, FIG. 1 illustrates an operational environment 100 for providing a phishing detection engine 110, according to an embodiment herein. As shown, the operational environment 100 includes client devices 102A-C. Broadly speaking, the client devices 102A-C may include personal computers, tablet computers, mobile phones, gaming consoles, wearable devices, Internet of Things (IoT) devices, and any other suitable devices, of which system 1100 in FIG. 11 is also broadly representative. It should be appreciated that while only three client devices 102A-C are depicted for ease of illustration, any number of client devices 102A-C are contemplated herein.

As illustrated, the client devices 102A-C are in operable communication with the phishing detection engine 110. In some cases, the phishing detection engine 110 may be executed remotely from the client devices 102A-C, and as such the client devices 102A-C may communicate with the phishing detection engine 110 via one or more networks, including the Internet, intranets, wired and wireless networks, local area networks (LANs), wide area networks (WANs), or any combination thereof. In other cases, the phishing detection engine 110 is installed and executed locally on the client devices 102A-C. While in still further cases, one or more functions of the phishing detection engine 110 is installed and executed locally on the client devices 102A-C while the remaining functions are remotely executed.

The client devices 102A-C may be vulnerable to phishing attacks due to the presence of applications that are commonly targeted by cybercriminals. For example, mail applications running on the client devices 102A-C are often the primary entry point for phishing attempts, with attackers sending deceptive emails designed to look legitimate and prompt users to click malicious links or download harmful attachments. Similarly, web browsers used by the client devices 102A-C are at risk when users are redirected to fake websites that closely mimic trusted platforms, such as banking sites or online retailers, in an attempt to steal login credentials or personal information. Additionally, instant messaging apps and social media platforms, commonly used on the client devices 102A-C, can be exploited by attackers to distribute phishing links or impersonate trusted contacts. Since these applications are frequently used and often lack sufficient protection against evolving phishing techniques, the client devices 102A-C remain prime targets for attackers seeking to exploit vulnerabilities and gain unauthorized access to sensitive data.

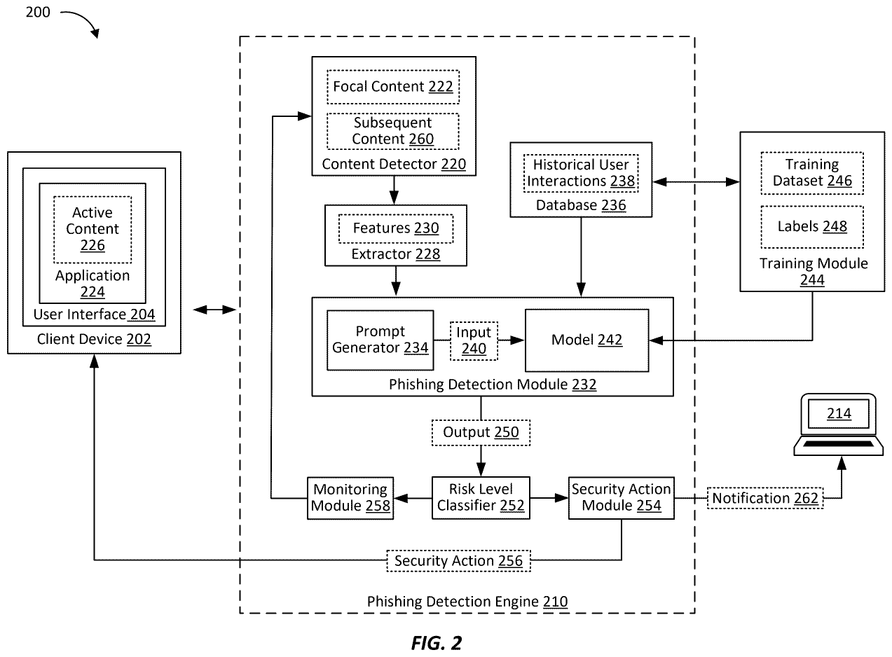

To safeguard the client devices 102A-C against phishing attacks, the phishing detection engine 110 monitors content interactions performed on the client devices 102A-C. That is, the phishing detection engine 110 monitors content that a user interacts with via a user interface 104 of the client device 102A-C. For example, the user of the client device 102C is directed to a web-browser that provides a prompt 106. As shown, the prompt 106 includes a request for sensitive information, such as a username and password. The phishing detection engine 110 monitors this content interaction to determine whether this interaction indicates potential phishing activity. In particular, the phishing detection engine 110 captures the content displayed via the user interface 104, which includes the prompt 106, and determines whether this content includes features indicative of phishing activity. The details of capturing the displayed content are described in greater detail below with respect to FIGS. 2-9.

If the phishing detection engine 110 detects potential phishing activity, the phishing detection engine 110 responsively acts to prevent or limit the phishing activity. For example, the phishing detection engine 110 may block a respective website or the user from further interacting with the suspicious content. As illustrated, this may include generating a notification 108 of the respective security action, here blocking of the suspicious website. As will be expanded on in greater detail below, in some cases, if the focal content includes some features of phishing activity but are not conclusive or determinative of a phishing attack, the phishing detection engine 110 monitors subsequent content interactions to determine whether the interaction as a whole indicates potential phishing activity.

In some embodiments, the phishing detection engine 110 is in operable communication with a security system 112, typically via networks, including local or wide-area networks, or over the internet. This communication enables the phishing detection engine 110 to leverage the security system 112 for enhanced protection of the client devices 102A-C against a range of cyber threats, including phishing attacks. The security system 112 may consist of various software and hardware components designed to detect, block, and mitigate malicious activities in real time. Through this connection, the phishing detection engine 110 can transmit data about detected potential phishing activity, allowing the security system 112 to analyze and monitor cyber threats to the client devices 102A-C in a cohesive manner. For example, by informing the security system 112 of detected phishing activity, the phishing detection engine 110 enables the security system 112 to track, identify, and adapt to emerging phishing techniques, such as updating a training algorithm used to train the phishing detection engine 110 to reflect the latest phishing techniques and tricks. Additionally, the security system 112 may integrate with other enterprise-level security solutions, providing a comprehensive defense framework that helps ensure the ongoing safety of the client devices 102A-C.

The phishing detection engine 110 may also notify the security system 112 of any successful phishing attacks identified at the client devices 102A-C. For example, a user of the client device 102C may select a deceptive URL from an email message. Selection of the deceptive URL may cause a malicious download onto the client device 102C. As will be described in greater detail below, the phishing detection engine 110 detects the deceptive URL and malicious download associated with the phishing attack. In addition to alerting the client device 102C of the detected phishing activity, the phishing detection engine 110 generates a notification 116 of the attack and sends it to a client device 114 through the security system 112. The client device 114 may be associated with a user responsible for managing the security of the client devices 102A-C. By notifying the client device 114 of the phishing attack, the phishing detection engine 110 enables a timely response to the incident, helping to mitigate potential damage and minimize its impact on the affected devices and network.

As shown, the notification 116 generated by the phishing detection engine 110 may be displayed via the user interface 104 of the client device 114 and includes a risk level of the phishing activity as well as identification of the client device associated with the phishing activity. As will be described in greater detail below, the notification 116 may also include a summary 118 of the phishing activity, such as providing screenshots of the user interaction involving the phishing activity. The summary 118 may also include other information associated with the phishing activity, such as information about the malicious download file (e.g., filename) or deceptive URL. As can be appreciated, by providing this information to the security system 112, the security response can be executed more swiftly, as the security system 112 is able to immediately identify and address the malicious files or URLs based on the provided details. This active approach helps prevent further dissemination of the phishing attack and protects users from engaging with harmful content. Moreover, by sharing this data, security teams, such as the user of the client device 114, can quickly analyze patterns and update defenses to better detect and mitigate similar attacks in the future, enhancing the overall security posture of the operational environment 100.

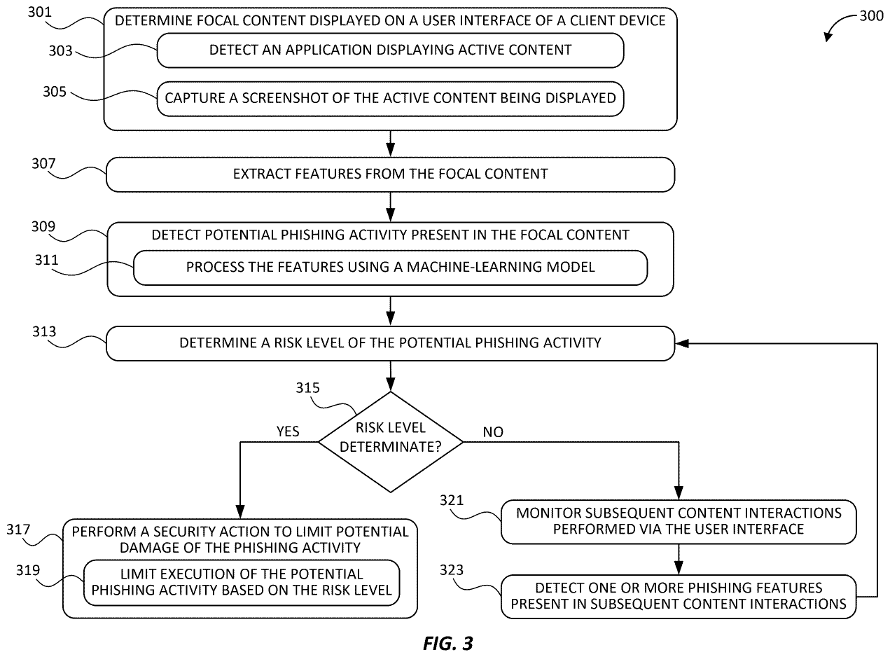

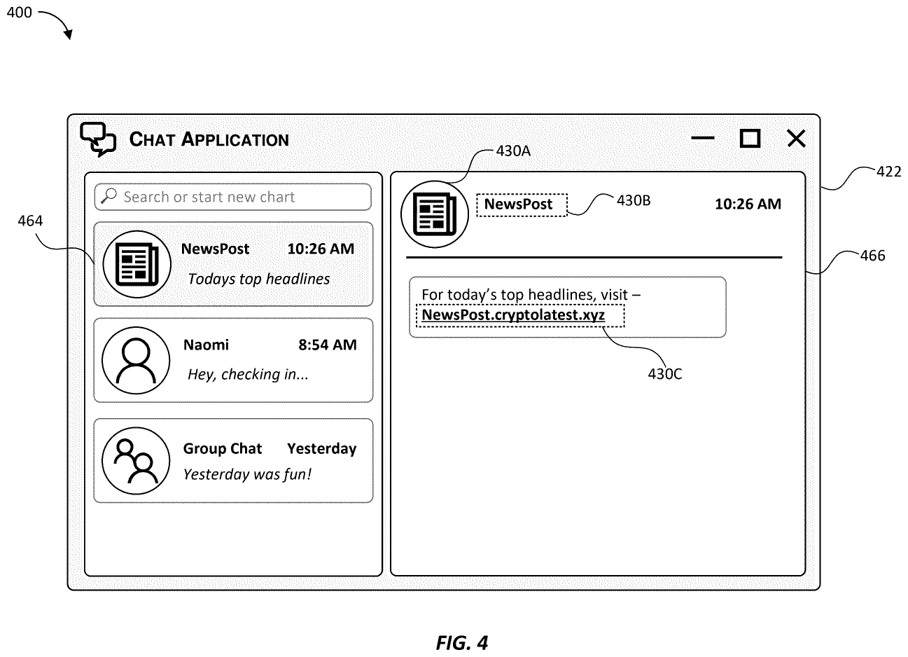

Referring now to FIG. 2, an example environment 200 in which a phishing detection engine 210 is leveraged to detect potential phishing activity is illustrated, according to an embodiment herein. For ease of explanation, FIG. 2 is described with reference to FIG. 3, which illustrates a process 300 for providing a phishing detection engine and one or more of its functions, according to an embodiment herein. While FIG. 3 is described in relation to FIG. 2, it should be appreciated that the process 300 is equally applicable to the remaining figures and components therein. FIG. 2 is also described with reference to FIGS. 4-10, each of which is referenced in turn in the following description.

As illustrated, the phishing detection engine 210 is in operational communication with a client device 202, which may be the same or similar to the phishing detection engine 110 and the client devices 102A-C, respectively. It should be appreciated that while the phishing detection engine 210 is illustrated as separate from the client device 202, in some embodiments, the phishing detection engine 210 may be installed and executed locally on the client device 202. The phishing detection engine 210 is in operable communication with the client device 202 to monitor for potential phishing activity. In particular, the phishing detection engine 210 monitors content interactions performed by a user of the client device 202 via a user interface 204 of the client device 202.

To monitor for potential phishing activity, the phishing detection engine 210 determines focal content 222 displayed on the user interface 204 (301). In particular, the phishing detection engine 210 includes a content detector 220 that detects the focal content 222 displayed on the client device 202. The focal content 222, as used herein, refers to the primary element or area that is currently the center of user interaction. For example, the content detector 228 may detect active content 226 presented via an application 224 executing on the client device 202. In such cases, the focal content 222 may be the same as active content 226 that the user is directly engaging with, such as by selecting, viewing, or modifying. As such, the focal content 222 dynamically reflects the component or information that holds the user's focus, guiding input and receiving real-time updates or commands based on the user's actions.

In some embodiments, the phishing detection engine 210 may initiate monitoring of a user's content interaction based on the application 224 running on the client device 202. That is, certain applications, such as those that are vulnerable to phishing attacks, may trigger the phishing detection engine 210, while other applications, such as secure applications or those with limited external communication (e.g., document editing applications), may not trigger the phishing detection engine 210. As such, in some embodiments, the content detector 220 may detect when an application 224 is initiated on the client device 202 and determine whether the application 224 corresponds to a monitored application or an unmonitored application. Monitored applications are applications that are identified for monitoring by the phishing detection engine 210, while unmonitored applications are applications that are identified as not requiring monitoring. Applications may be predefined as monitored or unmonitored by an organization, a respective security system, such as the security system 112, or a developer.

Following the above example, when the content detector 220 detects that application 224 has been launched, it evaluates whether application 224 is classified as a monitored or unmonitored application. If the content detector 220 determines that application 224 is an unmonitored application, it transitions to a low-power or sleep state until another application launch is detected. Conversely, if application 224 is identified as a monitored application, the content detector 220 initiates monitoring of the active content 226 displayed through application 224 to detect potential phishing activity.

In some cases, the content detector 220 determines the focal content 222 by identifying the active content 226 displayed via the user interface 204 (303). The active content 226 refers to the content that is the focus of the user's attention, such as content that is actively viewed or interacted with by the user. This may include the foreground window, a selected document, or a webpage currently in focus, representing the primary material the user engages with at any given time. In some cases, the process of determining the focal content 222 involves capturing the most relevant or prominent information (e.g., the active content 226) displayed within the application 224. In certain implementations, the content detector 220 achieves this by taking a direct screenshot of the active content 226 currently rendered on the user interface 204 (305). Capturing a screenshot ensures that the exact visual representation of the active content 226 is preserved for further analysis or processing. Alternatively, in other embodiments, the content detector 220 interacts programmatically with the application 224 by utilizing its application programming interface (API). This API communication enables the content detector 220 to extract data directly from the application without relying on visual capture, often providing a more structured and granular representation of the focal content 222.

Once the focal content 222 is captured, the phishing detection engine 210 extracts one or more features from the focal content 222 (307). In particular, the phishing detection engine 210 includes an extractor 228 that extracts the features 230 from the focal content 222. Feature extraction may involve analyzing the focal content 222 to identify key attributes, patterns, or elements that define its structure or meaning. Depending on the type of content, these features 230 may include textual elements, image elements, layout information, metadata, or other contextual markers. The textual elements can encompass recognized characters, words, or entire passages, while image elements may involve visual patterns, object recognition, or graphical components present in the focal content 222. The extractor 228 may utilize machine-learning models, computer vision algorithms, or natural language processing (NLP) techniques to extract these features 230, ensuring that both text and image-based aspects of the focal content 222 are accurately identified and categorized.

In an example, the extractor 228 applies optical character recognition (OCR) to the focal content 222, which consists of a screenshot of the active content 226. The OCR process analyzes the image to detect and convert any embedded text into machine-readable format. This allows the extractor 228 to extract textual elements from visual data, enabling further processing, such as indexing or keyword identification. By leveraging OCR, the extractor 228 can efficiently derive useful information from screenshots, even when the content is not directly accessible in a textual format. In addition to OCR, the extractor 228 may employ other processes to extract the features 230 such as textual and visual elements from the focal content 222. Examples include computer vision techniques which can identify and classify objects, icons, and graphical components within the focal content 222, allowing the extractor 228 to recognize logos, buttons, or other interface elements. NLP can be applied to detected text, enabling sentiment analysis, keyword extraction, or entity recognition. And for visual elements present within the focal content 222, image recognition algorithms may be leveraged to detect patterns, colors, and structural layouts, providing insights into the composition of the focal content 222. As can be appreciated, the extractor 228 may use one or more of these processes to extract the features 230, thereby enabling comprehensive extraction of both textual elements and visual elements from the focal content 222.

Once the features 230 are extracted, the phishing detection engine 210 processes the features 230 to detect potential phishing activity present in the focal content 222 (309). To process the features 230, the phishing detection engine 210 leverages a model 242 (311). As shown, the phishing detection engine 210 includes a phishing detection module 232 that includes a prompt generator 234 and the model 242. To process the features 230 to detect potential phishing activity, the features 230 are fed to the phishing detection module 232. Responsive to receiving the feature 230, the prompt generator 234 generates a prompt containing a request for the model 242 to determine whether the features 230 indicate any potential phishing activity. The prompt generator 234 generates the prompt to include the features 230 along with the request. The prompt is then fed into the model 242 as an input 240.

In some embodiments, the model 242 may be a lightweight machine learning model specifically designed for efficient execution on a client device 202, such as a mobile phone or a laptop. To ensure that it can operate within the resource constraints of the client device 202, the model 242 may be optimized to be computationally efficient, requiring minimal processing power and memory. As such, the model 242 may have an architecture that consists of fewer layers or simpler structures, enabling fast inference without significant latency. This architecture allows the model 242 to be installed directly on the client device 202, enabling real-time phishing activity analysis without the need for constant cloud-based processing.

In other scenarios, the model 242 may be cloud-based thereby allowing for more complex and computationally demanding processing, as it is not constrained by the limited resources of the client device 202. In such cases, the model 242 may be a more powerful and intricate machine learning model, such as a large neural network or a deep learning model, requiring processing power, memory, and storage beyond that of the client device 202. In scenarios where the model 242 is cloud-based, its architecture may involve multiple layers or advanced structures like recurrent neural networks (RNNs) or transformers, which are capable of processing larger volumes of data and capturing more complex patterns. Since the model 242 is not installed directly on the client device 202, it communicates with the device 202 over a network, relying on cloud-based infrastructure for one or more for the functions described herein.

Regardless of its executional relation to the client device 202, the model 242 may be or include a variety of advanced machine learning techniques and algorithms to enhance its performance in detecting subtle patterns within the features 230. For instance, the model 242 may incorporate techniques such as transfer learning, where a pre-trained model is fine-tuned on domain-specific data, such as described below with respect to historical user interactions 238, improving its ability to generalize to new examples. Additionally, the model 242 may include ensemble methods, combining multiple models to improve accuracy and robustness in predicting phishing activity. The model 242 may employ NLP techniques, such as tokenization, phishing activity scoring, and contextual analysis, to more accurately interpret the context of the focal content 222. The model 242 may also integrate adaptive learning algorithms, enabling it to continuously improve its performance over time based on user feedback or new data (e.g., subsequent content interactions). This flexibility ensures that the model 242 remains effective, whether it is running locally on the client device 202 or remotely, by using the most appropriate techniques for the given context and available resources.

The model 242 is trained using a training module 244, which manages the process of learning from a carefully curated dataset. The training dataset 246 consists of examples of content, where each example is labeled with the presence or absence of phishing activity. These labels 248 serve as the ground truth, helping the model 242 learn to differentiate between subtle cues and patterns within the features 230 extracted from the focal content 222. Training the model 242 involves iterating through the dataset 246, allowing the model 242 to adjust its parameters based on the labeled 248 and the training dataset 246. As the model 242 learns, it becomes increasingly adept at detecting these nuanced expressions of phishing activity present within features of various content, which may otherwise go unnoticed by the end user.

In some embodiments, the training dataset 246 incorporates historical user interactions 238 to tailor the model 242 to a respective user or client device, such as the client device 202. That is, by leveraging the historical user interactions 238 of a respective user or client device, the model 242 can be personalized, improving its ability to detect phishing activity in a manner that aligns with the user's unique preferences, everyday content interactions, or communication style. This allows for more accurate and contextually appropriate phishing detection analysis, ensuring that the model 242 provides accurate identification of phishing activity, and limits false alarms based on content the user typically interacts with. For example, the model 242 may learn over time that the user of the client device 202 often visits a particular URL. Since this URL is visited within the normal course of use, the phishing detection module 232 may identify communications containing the URL as unlikely to be related to phishing activity.

As shown, the historical user interactions 238 may be stored in a database 236. While the database 236 is illustrated as part of the phishing detection engine 210, it should be noted that in some embodiments, the database 236 may be remotely located, such as in a cloud-based infrastructure. The historical user interactions 238 are continuously updated as the user of the client device 202 interacts with content. This ongoing collection of interaction data enables the model 242 to adapt and refine its predictions over time, allowing it to better mirror the user's evolving behavior, preferences, and content interaction patterns. By incorporating these updates, the model 242 can provide increasingly personalized and accurate insights, ensuring that phishing activity detection is accurate.

A goal of the model 242 is to detect phishing activity that may not be easily perceptible to users. As described above, phishing attacks are continuously evolving, often alluding detection, even from astute users. As such, the model 242 analyzes the features 230 to identify nuanced cues, which can be embedded in the focal content 222 in ways that are too subtle or complex for humans to identify at a glance, which is often the amount of time user's spend analyzing content. By analyzing the features 230, sometimes in combination with the features of previous content interactions, the model 242 is able to identify even the faintest traces of phishing activity which would allude conventional phishing detection approaches or a typical user.

In response to receiving the input 240, the model 242 processes the extracted features 230 and generates an output 250. The output 250 may take the form of a score or probability that indicates the likelihood of a potential phishing activity being present within the focal content 222. For instance, the model 242 could output a score on a continuous scale, where values closer to the negative end of the range represent a lack of phishing activity, and values closer to the positive end indicate an increased likelihood of phishing activity. In this context, a low score might suggest no phishing activity within the focal content 222, while a high score indicates potential phishing activity.

Alternatively, the output 250 may include a discrete classification based on the model's interpretation of the features 230. This classification could be a binary decision, such as “phishing activity” or “no phishing activity,” or it could involve multiple categories, such as “phishing activity,” “likely phishing activity,” “indeterminate,” “likely not phishing activity,” and “not phishing activity.” In such cases, the model 242 achieves this output by applying the learned weights and biases from its training phase to the input features, and using activation functions (e.g., sigmoid or softmax) to generate the final output 250. In cases where a probabilistic output is used, the model 242 might employ a softmax function to convert the raw output values into a probability distribution, ensuring that the sum of the probabilities for all categories equals 1. This probabilistic approach allows the model 242 to provide a more nuanced view of the features 230, assisting in more accurate phishing activity analysis for varied content types.

As shown, the output 250 is received by a risk level classifier 252, which determines a risk level of potential phishing activity for the features 230 (313). Depending on the format of the output 250, the risk level classifier 252 may classify the output 250 into an appropriate risk level category. For example, if the output 250 is a continuous score that indicates the likelihood of phishing activity within the features 230, the risk level classifier 252 may map the score to a predefined range, with thresholds corresponding to different levels of risk. In this case, the risk level classifier 252 may categorize the score into various risk levels such as “low,” “medium,” or “high,” based on where the score falls within the range. In some embodiments, the thresholds for categorizing the risk level of potential phishing activity are configurable by a user, an administrator, or user associated with the security system. In such cases, the thresholds may be adjusted to provide sufficient protection against phishing activity while minimizing false alarms.

Alternatively, if the output 250 is a discrete classification, such as a binary “phishing activity” or “clear of phishing activity” label or multiple categories (e.g., “determinate of phishing activity,” “determinant of no phishing activity,” or “indeterminate of phishing activity”), the risk level classifier 252 may assign a risk level based on the type or severity of the classification. For example, a classification of “determinate of phishing activity” could be classified as high risk, while a “clear of phishing activity” classification may be associated with low or no risk. This classification process allows the risk level classifier 252 to determine the appropriate security actions or response to the output 250 based on the potential impact of the phishing activity identified in the focal content 222.

In some embodiments, the risk level classifier 252 determines whether the risk level of the features 230 is determinate of phishing activity or not (315). This determination may be based on the risk level classification of the output 250. For example, if the output 250 is classified as “phishing activity” then the risk level classifier 252 determines that the features 230 are determinate of phishing activity. As such, the phishing detection engine 210 determines and performs a security action to limit potential damage of the phishing activity (317). This may involve restricting or preventing the execution of an activation step associated with potential phishing activity (319). As explained in greater detail below, this could include blocking access to a website, message, link, or download (e.g., the activation step) that facilitates the phishing activity.

As shown on FIG. 2, the phishing detection engine 210 includes a security action module 254. In some embodiments, the security action module 254 determines an appropriate security action 256 based on the risk level classification of the features 230 and, in some cases, the type of phishing activity present in the features 230. As noted above, the output 250 may include rationale that identifies which of the features 230 indicate potential phishing activity. The features 230 that indicate potential phishing activity are referred to herein as phishing features. For instance, the output 250 may identify a phishing feature, such as a deceptive URL. Based on the detection of this phishing feature, the security action module 254 determines that the appropriate security action 256 is to block access to the deceptive URL. In another example, the output 250 might identify an embedded script within an email that attempts to harvest user credentials. In response, the security action module 254 may initiate a security action 256 to quarantine the email and prevent user interaction with the malicious script.

The security action module 254 may automatically execute the security action 256 without requiring user intervention. This means that the security action module 254 can independently initiate or trigger the client device 202 to perform the necessary protective measures. Automating the security actions 256 provides significant benefits, such as ensuring rapid response to detected phishing activity, minimizing the time window in which malicious activities could succeed. Furthermore, automatic execution of the security actions 256 eliminates reliance on user awareness or decision-making, which can be inconsistent and prone to error, particularly when users are unfamiliar with the nuances of phishing schemes. By acting automatically, the phishing detection engine 210 maintains a consistent standard of security, reduces the cognitive burden on users, and enhances overall environment 200 resilience against sophisticated phishing attacks.

To provide an illustrative example of the phishing detection engine detecting potential phishing activity, reference is now made to FIG. 4 which includes an environment 400 illustrating focal content 422 identified as containing potential phishing activity, according to an embodiment herein. In particular, the focal content 422 depicts features 430A-C identified by the phishing detection engine 210 as containing one or more phishing features. That is, the phishing detection engine 210 processes the focal content 422 to determine it contains potential phishing activity. In an illustrative example, the phishing detection engine 210 determines the focal content 422 based in part on content 422 being presented by a chat application. This application, which may be the same or similar to the application 224, may be a known application-type vulnerable to phishing attacks. As such, when a respective user launches the chat application, the phishing detection engine 210 begins monitoring the focal content 422 for potential phishing activity.

The environment 400 may be illustrative a screenshot captured by the content detector 220 of a user interaction with the chat application. As shown, the user selected a communication 464 which opened a respective message pane 466 containing the features 430A-C. The features 430A-C include a logo 430A, a business name-NewsPost 430B, and a link 430C. Upon capturing the focal content 422, the phishing detection engine 210 extracts the features 430A-C and processes the features 430A-C. For example, the phishing detection engine 210 submits the features 430A-C to the model 242 for processing. The model 242 processes the features 430A-C and generates the output 250 classifying the features 430A-C as “phishing activity.” It should be appreciated that additional features may be extracted and processed beyond the features 430A-C, and that the features 430A-C are limited for ease of reference.

In some embodiments, the phishing detection engine 210 may request a rationale for the output 250 from the model 242. In such cases, the model 242 may provide a rationale for a particular score or classification as part of the output 250. In the illustrated example, the output 250 includes the rationale of “the message appears to be a phishing attempt as it impersonates “NewsPost,” a likely official entity, and contains a suspicious link. The URL uses a domain “cryptolatest.xyz”, which is unrelated to any legitimate postal service and suggests malicious intent.” In other words, the model 242 detects the phishing activity due, in part, to differences detected between the features 430A-C, determining that the feature 430C does not correspond to the features 430A-B. The risk level classifier 252 may determine a high-risk of phishing activity due to the deceptive URL and its unrelatedness to the NewsPost entity.

Responsive to determining that the features 430A-C indicate potential phishing activity within the focal content 422, the phishing detection engine 210 performs one or more security actions. Due to the high risk level of the phishing activity and the presence of the deceptive URL, the phishing detection engine 210 selects a security action 256 that prevents execution of an activation step for the phishing activity. That is, the phishing detection engine 210 blocks the deceptive URL detected by the feature 430C.

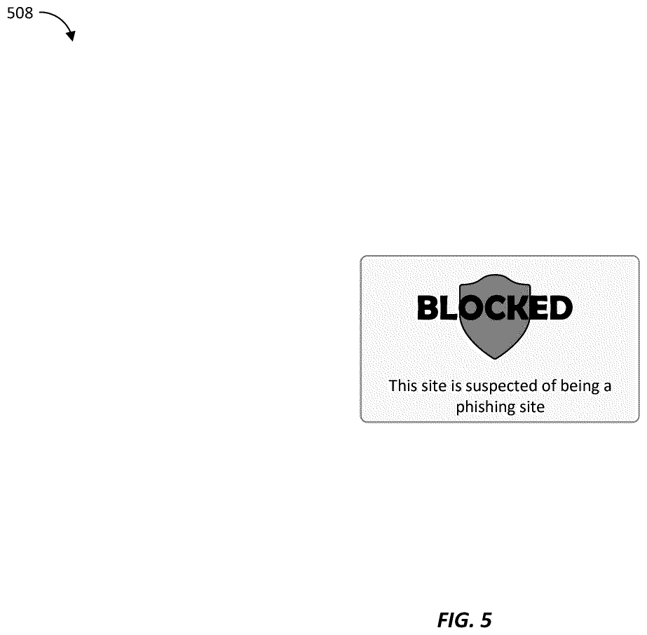

Referring now to FIG. 5, an example notification 508 provided to a client device responsive to a security action is illustrated, according to an embodiment herein. For instance, the notification 508 may be generated by the phishing detection engine 210 and displayed via the user interface 204 responsive to identifying that the focal content 422 contains potential phishing activity. In some embodiments, the notification 508 is generated and displayed on the client device 202 responsive to a user selecting the deceptive URL of the feature 430C, while in other embodiments, the notification 508 is displayed responsive to detecting the potential phishing activity.

Returning now to FIG. 2, as noted above, in some embodiments the risk level classifier 252 determines that the risk level of the features 230 is indeterminate of potential phishing activity (315). That is, based on the features 230, the model 242 generates an inconclusive output 250, indicating that it cannot identify potential phishing activity within the focal content 222 with a high degree of confidence. Similarly, the model 242 is unable to determine the absence of phishing activity with a high degree of confidence. This lack of certainty in the output 250 results in an indeterminate classification. Consequently, the risk level classifier 252 evaluates the output 250, whether it is a score, rationale, or a discrete classification itself, and assigns an indeterminate risk level, reflecting the uncertainty in phishing activity and the inherent ambiguity in the focal content 222.

In cases where the risk level is indeterminate, the phishing detection engine 210 determines additional information is required to make a determination with respect to potential phishing activity. As such, the phishing detection engine 210 monitors subsequent content interactions 260 performed via the user interface 204 (321). In particular, the phishing detection engine 210 includes a monitoring module 258 that coordinates with the content detector 220 to monitor subsequent content interactions 260 performed via the user interface 204. The subsequent content interactions 260 include any interactions made by the user with the active content 226 after the indeterminate output 250 is generated.

To monitor the subsequent content interactions 260, the phishing detection engine 210 performs one or more steps described above. For example, the content detector 220 may capture the subsequent content interactions 260 similar to the focal content 222, such as taking a screenshot of the active content 226 being displayed via the user interface 204. In some embodiments, the subsequent content interactions 260 are captured at predefined time intervals after the output 250 is determined indeterminate. Then, the extractor 228 extracts the features from the subsequent content interactions 260 and submits these features to the phishing detection module 232. In some embodiments, the features 230 corresponding to the initial focal content 222 are submitted along with the features of the subsequent content interactions 260 to provide a cohesive view of the potential phishing activity.

The features from the subsequent content interactions 260, and in some cases, the features 230, are submitted to the model 242 as the input 240 requesting identification of any potential phishing activity. As described above, responsive to receiving the input 240, the model 242 generates the output 250. If the output 250 is indeterminate of phishing activity, the phishing detection engine 210 iterates through the above steps again. That is, responsive to determining that the output 250 is indeterminate of phishing activity or an absence of phishing activity, the monitoring module 258 coordinates with the content detector 220 to capture the subsequent content 260 at this subsequent time.

The phishing detection engine 210 iterates through this process until the output 250 provides a determinative risk level. As noted above, this includes a classification of either potential phishing activity or an absence of potential phishing activity. For instance, if the phishing detection engine 210 detects one or more phishing features present in the subsequent content interactions (323), such as indicated in the output 250, the phishing detection engine 210 determines that the risk level is determinate of potential phishing activity (315). As such, the phishing detection engine 210 performs a respective security action 256 to limit the potential damage of the phishing activity.

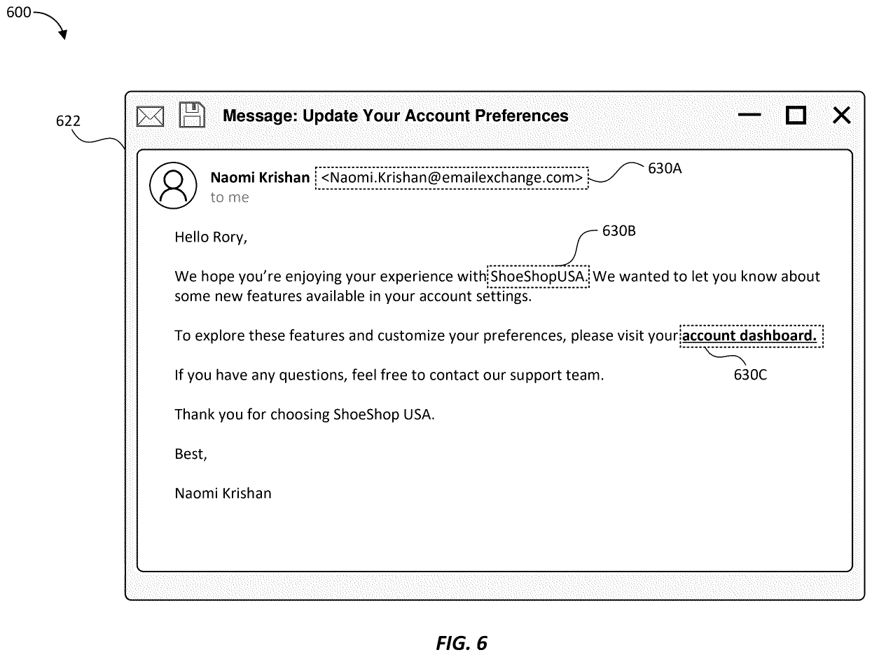

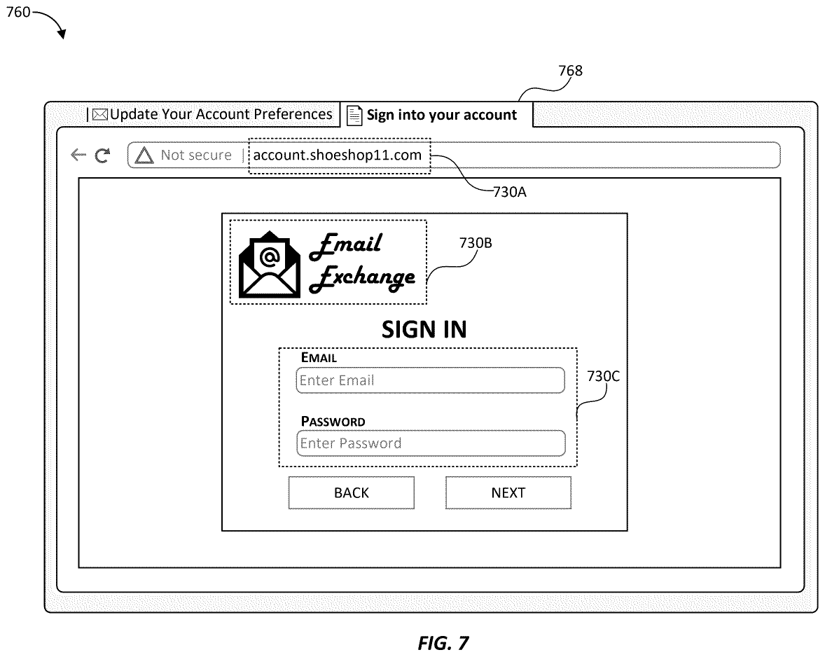

To illustrate an example involving an indeterminate risk level or classification, reference is now made to FIGS. 6 and 7. For ease of discussion, FIGS. 6 and 7 are discussed with respect to FIG. 2. FIG. 6 illustrates an example 600 including focal content 622, according to an embodiment herein. The focal content 622 is captured by the phishing detection engine 210 and features 630A-C are extracted responsively. It should be appreciated that while the features 630A-C are referenced for the following discussion, the phishing detection engine 210 extracts additional features from the focal content 622 for the phishing activity process.

Once extracted, the features 630A-C are submitted into the phishing detection module 232 where the phishing detection module 232 generates a prompt requesting the model 242 to identify any potential phishing activity present in the focal content 622. Responsive to receiving the prompt as the input 240, the model 242 generates the output 250. In the illustrated example 600, the output 250 is an “uncertain” classification. Along with this classification, the output 250 provides the rationale for the classification: “the email is from an EmailExchange domain but mentions a service called ‘ShoeShop USA,’ which seems unrelated. The email asks the recipient to visit an ‘account dashboard,’ Without seeing the URL of this link, it's difficult to confirm if its phishing or not. The user of the familiar company domain ‘EmailExchange’ could be misleading.”

Since the classification is “uncertain,” the risk level classifier 252 determines that the risk level of the focal content 622 is indeterminate. As such, the phishing detection engine 210 monitors the subsequent content interactions 260. FIG. 7 illustrates a subsequent content interaction 760, according to an embodiment herein. The subsequent content interaction 760 is subsequent to the focal content 622 in that the user selected the account dashboard link indicated by the feature 630C. This selection routed the user to a webpage 768 depicted in the subsequent content interaction 760. From the subsequent content interaction 760, the feature extractor 228 extracts the features 730A-C. As shown, the feature 730A includes a URL, the feature 730B includes a logo, and the feature 730C includes text indicating a sign-in request. As noted above, while additional features are extracted from the subsequent content interaction 760, the features 730A-C are limited for ease of illustration.

The features 730A-C are submitted into the model 242 which responsively generates the output 250. The output 250 classifies the features 730A-C into a “Phishing” classification and provides the rationale of “the URL shown in the screenshot is “account. ShoeShop11.com” which is not a typical EmailExchange domain. The login page is branded to look like an EmailExchange sign-in page, but the URL does not relate to any known EmailExchange service, suggesting it might be an attempt to mimic a legitimate EmailExchange login page for phishing purposes.” Based on this classification, the phishing detection action blocks the URL identified by the feature 730A, and displays the notification 508 on the user interface 204.

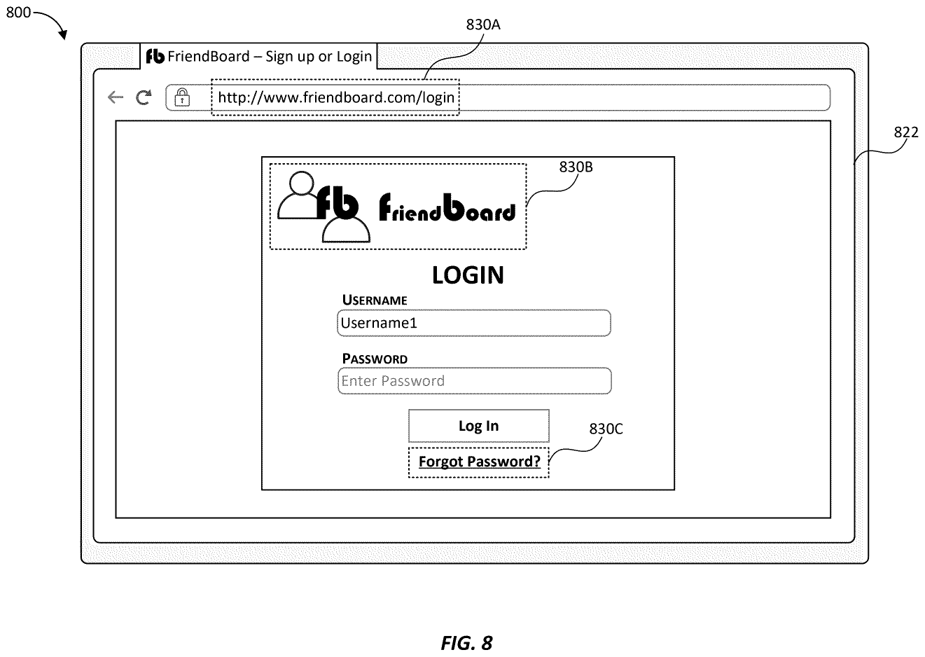

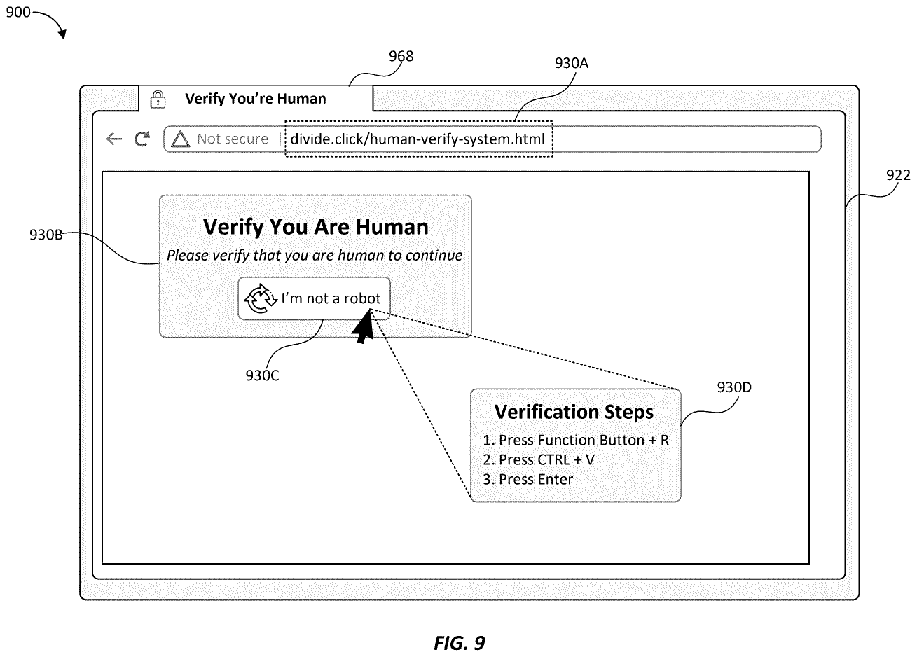

Referring now to FIGS. 8 and 9, another example scenario in which the phishing detection engine is leveraged is provided, according to an embodiment herein. FIG. 8 illustrates an example 800 depicting focal content 822 containing features 830A-C. Upon extraction and processing of the features 830A-C from the focal content 822, the phishing detection engine 210 determines a classification of “Not Phishing” for the focal content 822. The rationale provided by the model 242 for this classification is “the screenshot shows a login page with a URL that appears to be a legitimate FriendBoard URL using HTPPS, indicating a secure connection. There are no clear signs of phishing, such as misspellings or unusual requests for sensitive information directly.” Based on the “No Phishing” classification, the phishing detection engine 210 refrains from performing any security actions.

FIG. 9 illustrates an example 900 depicting focal content 922 captured by the phishing detection engine 210 at a subsequent time to the analysis of the focal content 822. For example, the user may have selected the “Forgot Password” option identified as feature 830C. Upon selection of this option, the user is directed to the webpage 968 captured as the focal content 922. From the focal content 922, the phishing detection engine 210 extracts the features 930A-D and processes these features 930A-D for potential phishing activity. Upon processing the features 930A-D, the phishing detection engine 210 detects potential phishing activity. In particular, the phishing detection engine 210 determines a “Phishing” classification based on the features 930A-D and provides the rationale of “the screenshot shows an unusual domain name suggesting potential phishing attempt aimed at tricking users into verifying that they are human for malicious reasons. This type of prompt can often lead to further scams or malicious downloads.”

Responsive to determining that the focal content 922 contains potential phishing activity, the phishing detection engine 210 executes respective security actions to limit the damage of the identified phishing activity. In the illustrated example 900, the user selects the button to confirm ‘I'm not a robot.’ Based on this selection, the phishing activity is activated, causing a malicious file to be downloaded onto the client device 202. The phishing detection engine 210 detects this download and performs one or more security actions to limit the damage caused by this phishing attack.

With reference to FIG. 2, in some embodiments, security actions to limit the damage of detected phishing activity includes generating a notification 262 and providing it to a respective client device 214. The client device 214 may be associated with a security system, such as the security system 212. As such, by notifying the client device 214 of the detected phishing activity, the phishing detection engine 210 allows for swift response and corrective actions to be performed by the security system or team. To aid in a swift and corrective action to limit the damage of phishing activity, in particular a successful phishing attack (e.g., a downloaded malicious file), the phishing detection engine 210 generates a summary of the detected phishing activity. This summary includes the focal content 222 and the rationale on why the phishing activity is detected.

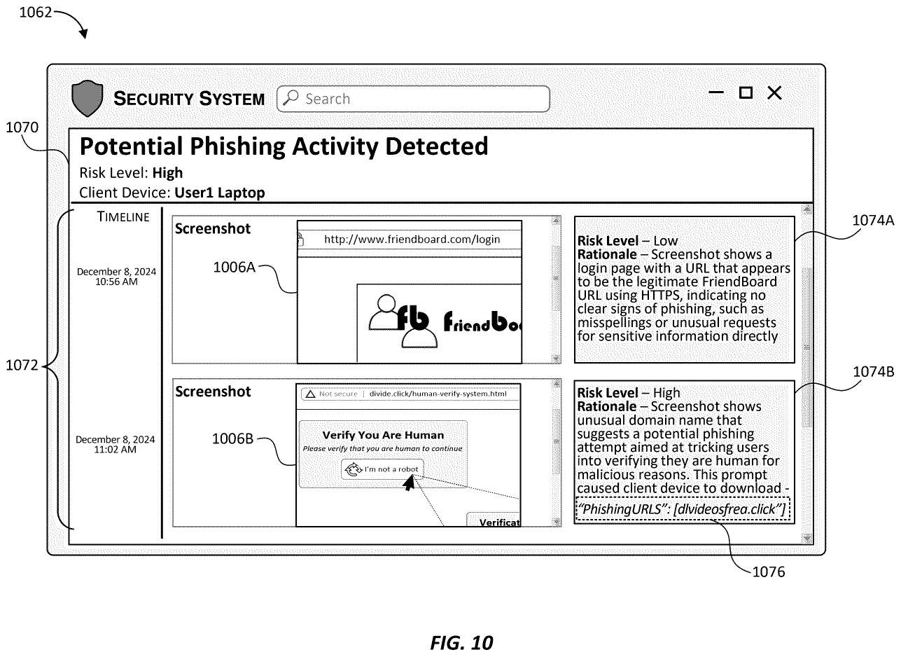

Referring now to FIG. 10, an example notification 1062 generated by the phishing detection engine 210 responsive to detecting activation of phishing activity is provided, according to an embodiment herein. In particular, the phishing detection engine 210 generates the notification 1062 responsive to detecting the malicious download executed by the user interacting with the focal content 922, as described above. The notification 1062 is generated by the phishing detection engine 210 and provided to the client device 214 to aid in limiting the damage caused by the phishing activity (e.g., the malicious download).

As shown, the notification 1062 includes a summary 1070 of the detected phishing activity. The summary 1070 identifies a risk level of the phishing activity as “High” and identifies the client device on which the phishing activity occurred as “User1 Laptop.” The summary 1070 also includes a timeline 1072 providing an overview of the user interactions that led to the phishing activity. In the illustrated example, the timeline 1072 includes the focal content 1006A-B, which are screenshots, as captured by the phishing detection engine 210. For each of the screenshots, the timeline 1072 provides the date and time at which the focal content 1006A-B was captured.

For each user interaction identified, the timeline 1072 includes an overview 1074A-B for each focal content 1006A-B. That is, the overview 1074A summarizes the phishing detection engine's 210 analysis of the focal content 1006A and provides the rationale as to why phishing activity was not detected from the focal content 1006A. Similarly, the overview 1074B summarizes the phishing detection engine's 210 analysis that the focal content 1006B and provides rationale as to why phishing activity was detected from the focal content 1006B. As shown in the overview 1074B, the summary 1070 includes the URL 1076 responsible for initiating the malicious download. By incorporating details related to the phishing activity, the summary 1070 equips the client device 214 with the critical information needed to identify, mitigate, or remediate the damage caused by the phishing attack. That is, information provided by the overviews 1074A-B enables faster response times and more effective countermeasures against similar threats in the future.

Referring to FIG. 11, FIG. 11 illustrates a system 1100 including a computing apparatus 1191 that may be used for providing a phishing detection engine and related functions, as described herein. For example, the client devices 102A-C, 114, 202, or 214 may be or include the computing apparatus 1191. As illustrated, the computing apparatus 1191 includes a processing system 1192 that includes a microprocessor and other circuitry that retrieves and executes software 1195 from storage system 1193. The processing system 1192 may be implemented within a single processing device but may also be distributed across multiple processing devices or sub-systems that cooperate in executing program instructions. Examples of the processing system 1192 include general purpose central processing units, graphical processing units, application specific processors, and logic devices, as well as any other type of processing device, combinations, or variations thereof.

The storage system 1193 may comprise any computer-readable storage media or medium readable by processing system 1192 and capable of storing software 1195. The storage system 1193 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 1193 may also include computer readable communication media over which at least some of the software 1195 may be communicated internally or externally. The storage system 1193 may be implemented as a single storage device but may also be implemented across multiple storage devices or sub-systems co-located or distributed relative to each other. The storage system 1193 may comprise additional elements, such as a controller capable of communicating with the processing system 1192 or possibly other systems.

The software 1195 (including phishing detection engine process 1196) may be implemented in program instructions and among other functions may, when executed by the processing system 1192, direct the processing system 1192 to operate as described with respect to the various operational scenarios, sequences, and processes illustrated herein. For example, the software 1195 may include program instructions for implementing a phishing detection engine and related functions, such as the process 300, as described herein. In some cases, the software 1195 may cause one or more features of the phishing detection engine process 1196 to provide or display respective components to a user via a user interface system 1199 inoperable communication with a client device, such as the client devices 102A-C, 114, 202, or 214.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 1195 may include additional processes, programs, or components, such as operating system software, virtualization software, or other application software. The software 1195 may also comprise firmware or some other form of machine-readable processing instructions executable by the processing system 1192.

In general, the software 1195 may, when loaded into the processing system 1192 and executed, transform a suitable apparatus, system, or device (of which computing apparatus 1191 is representative) overall from a general-purpose computing system into a special-purpose computing system customized to generate features, functionality, and user experiences provided by the phishing detection engine. Indeed, encoding the software 1195 on the storage system 1193 may transform the physical structure of the storage system 1193. The specific transformation of the physical structure may depend on various factors in different implementations of this description. Examples of such factors may include, but are not limited to, the technology used to implement the storage media of the storage system 1193 and whether the computer-storage media are characterized as primary or secondary storage, as well as other factors.

For example, if the computer readable storage media are implemented as semiconductor-based memory, the software 1195 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1197 may include communication connections and devices that allow for communication with other computing systems (not shown) over communication networks (not shown). Examples of connections and devices that together allow for inter-system communication may include network interface cards, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing apparatus 1191 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA), graphics processing units (GPUs), or neural processing units (NPUs) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), FPGAs, GPUs, NPUS, and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of which may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a phishing detection engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).
Example 1 is a computing apparatus comprising: a computer-readable storage media; a phishing detection engine comprising processor-executable instructions stored on the computer-readable storage media; and a processor coupled to the computer-readable storage media and configured to execute the processor-executable instructions, wherein the processor-executable instructions, when executed by the processor, direct the computing apparatus, to at least: determine focal content displayed on a user interface of a client device; extract a plurality of features from the focal content; detect potential phishing activity by processing the plurality of features using a machine-learning model; and perform a security action to limit execution of the potential phishing activity responsive to detection.
Example 2 is the computing apparatus of any previous or subsequent Example, wherein the processor-executable instructions to detect the potential phishing activity by processing the plurality of features using the machine-learning model, when executed by the processor, further direct the computing apparatus to: generate a prompt comprising the plurality of features and a request to detect phishing activity from the plurality of features; submit the prompt as an input into the machine-learning model; receive a score for the plurality of features as an output from the machine-learning model; determine a risk level that the plurality of features correspond to phishing activity based on the score; and detect the potential phishing activity based on the risk level.
Example 3 is the computing apparatus of any previous or subsequent Example, wherein the processor-executable instructions to extract a plurality of features from the focal content, when executed by the processor, further direct the computing apparatus to: detect an application displaying active content on the user interface, wherein the active content comprises the focal content; capture an image of the active content displayed by the application; and extract textual elements from the image.
Example 4 is the computing apparatus of any previous or subsequent Example, wherein the processor-executable instructions detect the potential phishing activity by processing the plurality of features using the machine-learning model, when executed by the processor, further direct the computing apparatus to: submit the plurality of features to the machine-learning model; receive an indeterminate score as output from the machine-learning model; monitor subsequent content interactions performed via the user interface with the focal content; and detect the potential phishing activity based on the subsequent content interactions.
Example 5 is the computing apparatus of any previous or subsequent Example, wherein the processor-executable instructions to perform the security action to limit execution of the potential phishing activity responsive to detection, when executed by the processor, further direct the computing apparatus to: block execution of an activation step for the potential phishing activity.
Example 6 is the computing apparatus of any previous or subsequent Example, wherein the phishing detection engine is executed locally on the client device.
Example 7 is method comprising: capturing, by a phishing detection engine, first content displayed via a user interface on a client device; detecting, by the phishing detection engine, potential phishing activity from the first content; monitoring, by the phishing detection engine, subsequent content interactions performed via the user interface; determining, by the phishing detection engine, a high-risk of phishing activity based on the subsequent content interactions; and performing, by the phishing detection engine, a security action to limit potential damage of the phishing activity.
Example 8 is the method of any previous or subsequent Example, wherein detecting, by the phishing detection engine, the potential phishing activity from the first content comprises: submitting, by the phishing detection engine, the first content as input into a machine-learning model; and identifying, by the phishing detection engine, the potential phishing activity from an output of the machine-learning model.
Example 9 is the method of any previous or subsequent Example, wherein monitoring, by the phishing detection engine, the subsequent content interactions performed via the user interface comprises: capturing, by the phishing detection engine, focal content displayed via the user interface at predefined time intervals after detecting the potential phishing activity from the first content; and processing, by the phishing detection engine, the focal content captured at the predefined time intervals for additional phishing activity.
Example 10 is the method of any previous or subsequent Example, wherein: monitoring, by the phishing detection engine, the subsequent content interactions performed via the user interface comprises: detecting, by the phishing detection engine, a user interaction with the first content, wherein the user interaction causes second content to be displayed via the user interface; and detecting, by the phishing detection engine, one or more phishing features present in the second content; and determining, by the phishing detection engine, the high-risk of phishing activity based on the subsequent content interactions comprises: determining, by the phishing detection engine, the high-risk of phishing activity based on the one or more phishing features present in the second content.
Example 11 is the method of any previous or subsequent Example, wherein detecting, by the phishing detection engine, the potential phishing activity from the first content comprises: detecting, by the phishing detection engine, one or more phishing features present in the first content; identifying, by the phishing detection engine, a plurality of historical user interactions associated with the client device; comparing, by the phishing detection engine, the one or more phishing features to the plurality of historical user interactions; and determining, by the phishing detection engine, that the first content comprises the potential phishing activity based on the comparison of the one or more phishing features to the plurality of historical user interactions.
Example 12 is the method of any previous or subsequent Example, wherein the method further comprises: capturing, by the phishing detection engine, second content displayed via the user interface on the client device; detecting, by the phishing detection engine, potential phishing activity from the second content; detecting, by the phishing detection engine, one or more phishing features present in the second content; identifying, by the phishing detection engine, a plurality of historical user interactions associated with the client device; comparing, by the phishing detection engine, the one or more phishing features to the plurality of historical user interactions; and determining, by the phishing detection engine, a low risk of phishing activity for the second content based on the comparison of the one or more phishing features to the plurality of historical user interactions.
Example 13 is the method of any previous or subsequent Example, wherein capturing, by the phishing detection engine, the first content displayed via the user interface on the client device comprises: detecting, by the phishing detection engine, an application displaying active content on the user interface; capturing, by the phishing detection engine, a screenshot of the active content being displayed; and extracting, by the phishing detection engine, the first content from the screenshot, wherein the first content comprises one or more of: textual elements; or image elements.
Example 14 is the method of any previous or subsequent Example, wherein the method further comprises: detecting, by the phishing detection engine, execution of the phishing activity; and performing, by the phishing detection engine, the security action to limit potential damage of the phishing activity comprises: generating, by the phishing detection engine, a summary of the phishing activity, wherein the summary comprises: screenshots of the subsequent content interactions; and identification of one or more phishing features within the first content that correspond to the phishing activity; and providing, by the phishing detection engine, the summary to a security system associated with the phishing detection engine.
Example 15 is a computer readable storage media comprising processor-executable instructions configured to cause a processor to: determine, by a phishing detection engine, first content displayed via a user interface on a client device; extract, by the phishing detection engine, a plurality of features from the first content; detect, by the phishing detection engine, potential phishing activity from the plurality of features; determine, by the phishing detection engine, a risk level of the potential phishing activity; and perform, by the phishing detection engine, a security action to limit execution of the potential phishing activity based on the risk level.
Example 16 is the computer readable storage media of any previous or subsequent Example, wherein the processor-executable instructions to detect, by the phishing detection engine, the potential phishing activity from the plurality of features cause the processor to further execute processor-executable instructions stored in the computer readable storage media to: generate, by the phishing detection engine, a prompt comprising the plurality of features; submit, by the phishing detection engine, the prompt as input into a machine-learning model; and receive, by the phishing detection engine, an output from the machine-learning model comprising one or more phishing features from the plurality of features that indicate potential phishing activity.
Example 17 is the computer readable storage media of any previous or subsequent Example, wherein: the processor-executable instructions to determine, by the phishing detection engine, the risk level of the potential phishing activity cause the processor to further execute processor-executable instructions stored in the computer readable storage media to: determine, by the phishing detection engine, that the potential phishing activity is high risk; and the processor-executable instructions to perform, by the phishing detection engine, the security action to limit execution of the potential phishing activity based on the risk level cause the processor to further execute processor-executable instructions stored in the computer readable storage media to: block, by the phishing detection engine, an activation step of the potential phishing activity.
Example 18 is the computer readable storage media of any previous or subsequent Example, wherein: the processor-executable instructions to determine, by the phishing detection engine, the risk level of the potential phishing activity cause the processor to further execute processor-executable instructions stored in the computer readable storage media to: determine, by the phishing detection engine, that the risk level of the potential phishing activity is indeterminate; and the processor-executable instructions to perform, by the phishing detection engine, the security action to limit execution of the potential phishing activity based on the risk level cause the processor to further execute processor-executable instructions stored in the computer readable storage media to: monitor, by the phishing detection engine, subsequent content interactions with the first content performed via the user interface; reevaluate, by the phishing detection engine, the risk level of the potential phishing activity in view of the subsequent content interactions; determine, by the phishing detection engine, that the potential phishing activity is high risk based on the subsequent content interactions; and prevent, by the phishing detection engine, further content interactions with the first content on the user interface based on the potential phishing activity being high risk.
Example 19 is the computer readable storage media of any previous or subsequent Example, wherein the processor-executable instructions cause the processor to further execute processor-executable instructions stored in the computer readable storage media to: capture, by the phishing detection engine, second content displayed via the user interface on the client device; detect, by the phishing detection engine, potential phishing activity from the second content; detect, by the phishing detection engine, one or more phishing features present in the second content; identify, by the phishing detection engine, a plurality of historical user interactions associated with the client device; and determine, by the phishing detection engine, a low risk of phishing activity for the second content based on the plurality of historical user interactions and the one or more phishing features of the second content.
Example 20 is the computer readable storage media of any previous or subsequent Example, wherein: the processor-executable instructions to determine, by the phishing detection engine, the first content displayed via the user interface on the client device cause the processor to further execute processor-executable instructions stored in the computer readable storage media to: detect, by the phishing detection engine, an application displaying active content on the user interface; and capture, by the phishing detection engine, a screenshot of the active content being displayed; and the processor-executable instructions to extract, by the phishing detection engine, the plurality of features from the first content cause the processor to further execute processor-executable instructions stored in the computer readable storage media to: extract, by the phishing detection engine, the first content from the screenshot, wherein the first content comprises one or more of: textual elements; or image elements.

What is claimed is:

1. A computing apparatus comprising:
a computer-readable storage media;
a phishing detection engine comprising processor-executable instructions stored on the computer-readable storage media; and
a processor coupled to the computer-readable storage media and configured to execute the processor-executable instructions, wherein the processor-executable instructions, when executed by the processor, direct the computing apparatus, to at least:
determine focal content displayed on a user interface of a client device;
extract a plurality of features from the focal content;
detect potential phishing activity by processing the plurality of features using a machine-learning model; and
perform a security action to limit execution of the potential phishing activity responsive to detection.

2. The computing apparatus of claim 1, wherein the processor-executable instructions to detect the potential phishing activity by processing the plurality of features using the machine-learning model, when executed by the processor, further direct the computing apparatus to:
generate a prompt comprising the plurality of features and a request to detect phishing activity from the plurality of features;
submit the prompt as an input into the machine-learning model;
receive a score for the plurality of features as an output from the machine-learning model;
determine a risk level that the plurality of features correspond to phishing activity based on the score; and
detect the potential phishing activity based on the risk level.

3. The computing apparatus of claim 1, wherein the processor-executable instructions to extract a plurality of features from the focal content, when executed by the processor, further direct the computing apparatus to:
detect an application displaying active content on the user interface, wherein the active content comprises the focal content;
capture an image of the active content displayed by the application; and
extract textual elements from the image.

4. The computing apparatus of claim 1, wherein the processor-executable instructions detect the potential phishing activity by processing the plurality of features using the machine-learning model, when executed by the processor, further direct the computing apparatus to:
submit the plurality of features to the machine-learning model;
receive an indeterminate score as output from the machine-learning model;
monitor subsequent content interactions performed via the user interface with the focal content; and
detect the potential phishing activity based on the subsequent content interactions.

5. The computing apparatus of claim 1, wherein the processor-executable instructions to perform the security action to limit execution of the potential phishing activity responsive to detection, when executed by the processor, further direct the computing apparatus to:
block execution of an activation step for the potential phishing activity.

6. The computing apparatus of claim 1, wherein the phishing detection engine is executed locally on the client device.

7. A method comprising:
capturing, by a phishing detection engine, first content displayed via a user interface on a client device;
detecting, by the phishing detection engine, potential phishing activity from the first content;
monitoring, by the phishing detection engine, subsequent content interactions performed via the user interface;
determining, by the phishing detection engine, a high-risk of phishing activity based on the subsequent content interactions; and
performing, by the phishing detection engine, a security action to limit potential damage of the phishing activity.

8. The method of claim 7, wherein detecting, by the phishing detection engine, the potential phishing activity from the first content comprises:
submitting, by the phishing detection engine, the first content as input into a machine-learning model; and
identifying, by the phishing detection engine, the potential phishing activity from an output of the machine-learning model.

9. The method of claim 7, wherein monitoring, by the phishing detection engine, the subsequent content interactions performed via the user interface comprises:
capturing, by the phishing detection engine, focal content displayed via the user interface at predefined time intervals after detecting the potential phishing activity from the first content; and
processing, by the phishing detection engine, the focal content captured at the predefined time intervals for additional phishing activity.

10. The method of claim 7, wherein:
monitoring, by the phishing detection engine, the subsequent content interactions performed via the user interface comprises:
detecting, by the phishing detection engine, a user interaction with the first content, wherein the user interaction causes second content to be displayed via the user interface; and
detecting, by the phishing detection engine, one or more phishing features present in the second content; and
determining, by the phishing detection engine, the high-risk of phishing activity based on the subsequent content interactions comprises:
determining, by the phishing detection engine, the high-risk of phishing activity based on the one or more phishing features present in the second content.

11. The method of claim 7, wherein detecting, by the phishing detection engine, the potential phishing activity from the first content comprises:
detecting, by the phishing detection engine, one or more phishing features present in the first content;
identifying, by the phishing detection engine, a plurality of historical user interactions associated with the client device;
comparing, by the phishing detection engine, the one or more phishing features to the plurality of historical user interactions; and
determining, by the phishing detection engine, that the first content comprises the potential phishing activity based on the comparison of the one or more phishing features to the plurality of historical user interactions.

12. The method of claim 7, wherein the method further comprises:
capturing, by the phishing detection engine, second content displayed via the user interface on the client device;
detecting, by the phishing detection engine, potential phishing activity from the second content;
detecting, by the phishing detection engine, one or more phishing features present in the second content;
identifying, by the phishing detection engine, a plurality of historical user interactions associated with the client device;
comparing, by the phishing detection engine, the one or more phishing features to the plurality of historical user interactions; and
determining, by the phishing detection engine, a low risk of phishing activity for the second content based on the comparison of the one or more phishing features to the plurality of historical user interactions.

13. The method of claim 7, wherein capturing, by the phishing detection engine, the first content displayed via the user interface on the client device comprises:
detecting, by the phishing detection engine, an application displaying active content on the user interface;
capturing, by the phishing detection engine, a screenshot of the active content being displayed; and
extracting, by the phishing detection engine, the first content from the screenshot, wherein the first content comprises one or more of:
textual elements; or
image elements.

14. The method of claim 7, wherein the method further comprises:
detecting, by the phishing detection engine, execution of the phishing activity; and
performing, by the phishing detection engine, the security action to limit potential damage of the phishing activity comprises:
generating, by the phishing detection engine, a summary of the phishing activity, wherein the summary comprises:
screenshots of the subsequent content interactions; and
identification of one or more phishing features within the first content that correspond to the phishing activity; and
providing, by the phishing detection engine, the summary to a security system associated with the phishing detection engine.

15. A computer readable storage media comprising processor-executable instructions configured to cause a processor to:
determine, by a phishing detection engine, first content displayed via a user interface on a client device;
extract, by the phishing detection engine, a plurality of features from the first content;
detect, by the phishing detection engine, potential phishing activity from the plurality of features;
determine, by the phishing detection engine, a risk level of the potential phishing activity; and
perform, by the phishing detection engine, a security action to limit execution of the potential phishing activity based on the risk level.

16. The computer readable storage media of claim 15, wherein the processor-executable instructions to detect, by the phishing detection engine, the potential phishing activity from the plurality of features cause the processor to further execute processor-executable instructions stored in the computer readable storage media to:
generate, by the phishing detection engine, a prompt comprising the plurality of features;
submit, by the phishing detection engine, the prompt as input into a machine-learning model; and
receive, by the phishing detection engine, an output from the machine-learning model comprising one or more phishing features from the plurality of features that indicate potential phishing activity.

17. The computer readable storage media of claim 15, wherein:
the processor-executable instructions to determine, by the phishing detection engine, the risk level of the potential phishing activity cause the processor to further execute processor-executable instructions stored in the computer readable storage media to:
determine, by the phishing detection engine, that the potential phishing activity is high risk; and
the processor-executable instructions to perform, by the phishing detection engine, the security action to limit execution of the potential phishing activity based on the risk level cause the processor to further execute processor-executable instructions stored in the computer readable storage media to:
block, by the phishing detection engine, an activation step of the potential phishing activity.

18. The computer readable storage media of claim 15, wherein:
the processor-executable instructions to determine, by the phishing detection engine, the risk level of the potential phishing activity cause the processor to further execute processor-executable instructions stored in the computer readable storage media to:
determine, by the phishing detection engine, that the risk level of the potential phishing activity is indeterminate; and
the processor-executable instructions to perform, by the phishing detection engine, the security action to limit execution of the potential phishing activity based on the risk level cause the processor to further execute processor-executable instructions stored in the computer readable storage media to:
monitor, by the phishing detection engine, subsequent content interactions with the first content performed via the user interface;
reevaluate, by the phishing detection engine, the risk level of the potential phishing activity in view of the subsequent content interactions;
determine, by the phishing detection engine, that the potential phishing activity is high risk based on the subsequent content interactions; and
prevent, by the phishing detection engine, further content interactions with the first content on the user interface based on the potential phishing activity being high risk.

19. The computer readable storage media of claim 15, wherein the processor-executable instructions cause the processor to further execute processor-executable instructions stored in the computer readable storage media to:
capture, by the phishing detection engine, second content displayed via the user interface on the client device;
detect, by the phishing detection engine, potential phishing activity from the second content;
detect, by the phishing detection engine, one or more phishing features present in the second content;
identify, by the phishing detection engine, a plurality of historical user interactions associated with the client device; and
determine, by the phishing detection engine, a low risk of phishing activity for the second content based on the plurality of historical user interactions and the one or more phishing features of the second content.

20. The computer readable storage media of claim 15, wherein:
the processor-executable instructions to determine, by the phishing detection engine, the first content displayed via the user interface on the client device cause the processor to further execute processor-executable instructions stored in the computer readable storage media to:
detect, by the phishing detection engine, an application displaying active content on the user interface; and
capture, by the phishing detection engine, a screenshot of the active content being displayed; and
the processor-executable instructions to extract, by the phishing detection engine, the plurality of features from the first content cause the processor to further execute processor-executable instructions stored in the computer readable storage media to:
extract, by the phishing detection engine, the first content from the screenshot, wherein the first content comprises one or more of:
textual elements; or
image elements.
